(19) United States
(12) Patent Application Publication
(10) Pub. No.: US 2019/0170099 A1
(43) Pub. Date: Jun. 6, 2019

(54) Partial Charging of Single Piston Fuel Pump

(71) Applicant: Stanadyne LLC, Windsor, CT (US)

(72) Inventor: Robert G. Lucas, Bonita Springs, FL (US)

(21) Appl. No.: 16/307,560

(22) PCT Filed: Jun. 2, 2017
(86) PCT No.: PCT/US17/35674

§ 371 Date: Dec. 6, 2018

Related U.S. Application Data
(60) Provisional application No. 62/346,070, filed on Jun. 6, 2016.

(51) Int. Cl. F02M 59/36; F02M 59/02; F02M 59/10; F02M 59/46; F04B 53/10

(52) U.S. Cl. CPC F02M 59/366; F02M 59/025; F04B 53/10; F02M 59/466; F02M 59/102

(57) ABSTRACT

The valve assembly and associated pump, direct a magnetic flux path such that a carefully timed magnetic force is directly applied to an inlet valve member when a coil is energized. As a result, direct actuation of the inlet valve is achieved. This accommodates a new partial charge operating strategy that has a significant benefit to inlet pressure pulsations. The benefit of a partial charging strategy is reduced inlet pulsations and noise, especially during vehicle idle conditions when it is most objectionable.

### BACKGROUND

The present invention relates to high pressure fuel pumps, and particularly to the inlet valve for feeding low pressure fuel to the high pressure pumping chamber.

Single piston and multi-piston high pressure common rail fuel pumps have been implemented to provide the high fuel pressures required by modern direct injected gasoline and diesel engines. These engine mounted pumps are volume controlled to minimize parasitic losses while maintaining rail pressure. Volume control is achieved either by inlet throttling using a magnetic proportional control valve, or indirect digital control of the inlet valve by a magnetic actuator. Either execution requires that the pump be controlled by an electrical signal from the engine ECU.

Because the indirect inlet valve actuator control requires a separate actuator for each pump piston, it has become common for multi-piston pumps to use a single inlet throttling proportional valve, in order to avoid a high part count and cost. Many modern single piston pumps use an indirect inlet valve actuator with a separate magnetically controlled armature assembly. These devices typically employ three separate components: inlet valve, magnetic armature, and the intervening engaging or connecting member. Different variants of this concept can be seen in U.S. Pat. Nos. 6,526,947, 7,513,240, 6,116,870, and 7,819,637. Due to the high complexity and precision of these devices, they typically account for at least ⅓ of the cost of a single piston pump. These digital type devices also suffer from high reciprocating mass and noise due to impact of the armature and valve assemblies during energizing and de-energizing events.

### SUMMARY

The object of the present invention is to improve the control, and reduce the cost and noise, of the inlet valve actuator for fuel pumps.

In one embodiment, the inlet valve is directly magnetically controlled. The valve assembly and associated pump, direct a magnetic flux path such that a carefully timed magnetic force is directly applied to the inlet valve member when a coil is energized. As a result, direct actuation of the inlet valve is achieved. This accommodates a new partial charge operating strategy that has a significant benefit to inlet pressure pulsations. The benefit of a partial charging strategy is reduced inlet pulsations and noise, especially during vehicle idle conditions when it is most objectionable.

In a standard digital control valve (with separate armature and valve) the valve automatically opens on the charging ramp of the cam, because it is decoupled from the armature. This results in a full charge of fuel into the pumping chamber. With the timing control of a direct magnetically actuated inlet valve, the inlet valve can be close it at any point on the cam, because it is directly coupled to the magnetic field.

The preferred direct magnetic inlet valve system to be controlled according to the present disclosure is described in U.S. application Ser. No. 15/062,774 filed Mar. 7, 2016 for “Direct Magnetically Controlled Inlet Valve for Fuel Pump”, the disclosure of which is hereby incorporated by reference. However, the benefit of the present invention can also be realized in other embodiments with other types of actuators if the valve is directly coupled to the armature.

### DETAILED DESCRIPTION

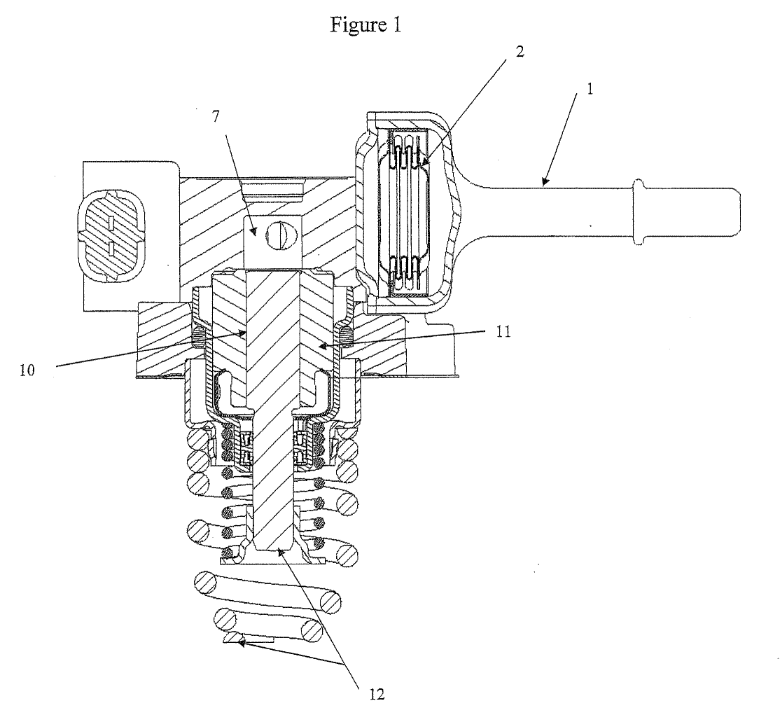

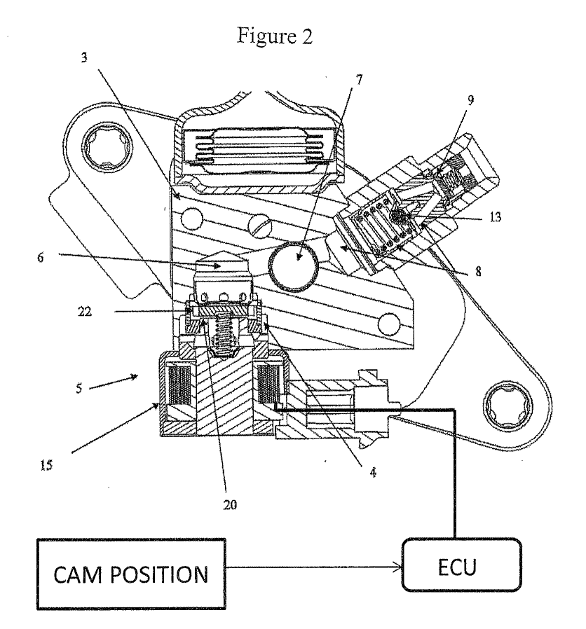

The basic functional aspects of the preferred hardware are evident from FIGS. 1 and 2. During the pump charging phase when piston 10 is reciprocally moving away from pumping chamber 7, low pressure fuel enters the pump through inlet fitting 1, passes around the pressure damper 2 and then into the pump housing 3 and a series of low pressure passages. It then enters into inlet annulus 4 assembly for the direct magnetically controlled inlet valve assembly 5, passes around the direct magnetically controlled inlet valve 22 through the passage 6 and into the pumping chamber 7. Upon completion of the charging phase the pumping camshaft acts upon a tappet 12, urging the piston 10, to slide in piston sleeve 11. When the direct magnetically controlled inlet valve assembly 5 is energized with an electrical current to coil assembly 15, a magnetic force is generated urging the inlet valve 22 to close and seal at surface 20, thereby enabling fuel trapped in the pumping chamber 7 to compress and build pressure. When sufficient pressure is built, the outlet valve 9 will open, allowing high pressure discharge flow to pass from the pumping chamber through the high pressure passages 8 past the outlet valve 9 and into the high pressure line, rail, and finally to feed the fuel injectors. The pump is equipped with a relief valve 13 in case there is a system malfunction.

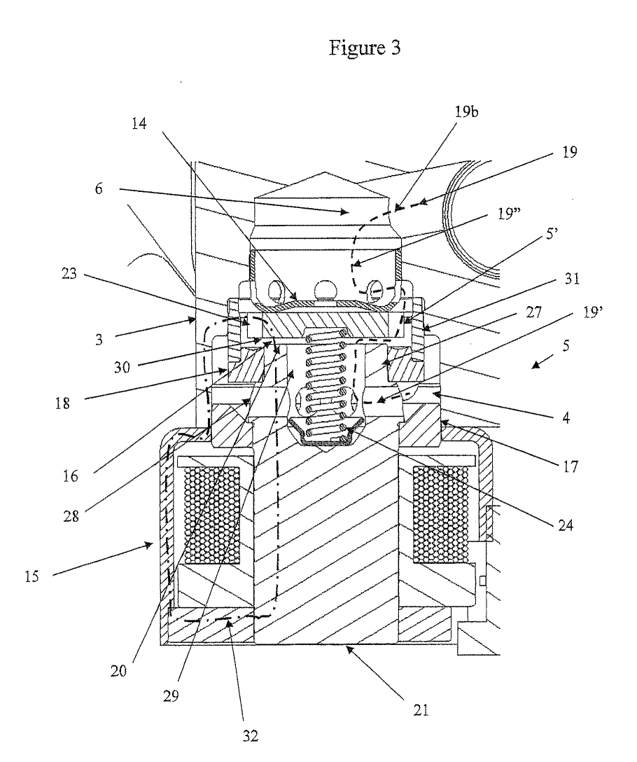

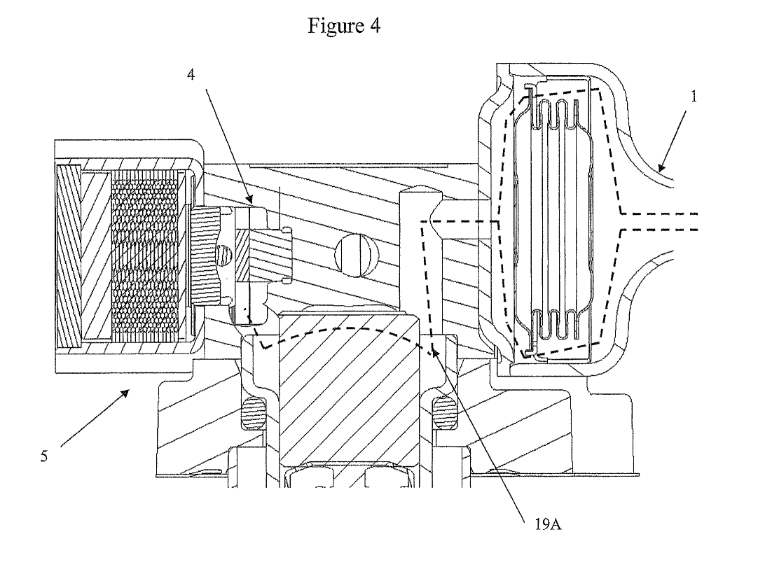

FIGS. 3 and 4 provide more detail into the functional aspects of the preferred embodiment. When the direct magnetically controlled inlet valve assembly 5 is de-energized during the charging phase of the pump, valve member 22 opens and fuel is allowed to pass along inlet fluid flow path circuit 19. During the charging phase fuel flows along path portion 19a from inlet fitting 1 to inlet valve inlet annulus 4, through the inlet valve 5, then along path portion 19b through passage 6 toward the pumping chamber. In the disclosed embodiment, the valve assembly 5 functions as both an inlet check valve and a quantity metering valve. During the charging phase, the downward movement of the pumping piston fills the pumping chamber with low pressure fuel from the inlet circuit 19. During the high pressure pumping phase of the piston, highly pressurized fuel cannot be permitted to backflow through passage 19′ to the inlet fitting. During this phase the valve member 22 is closed against sealing surface 20, due to both the energization of the coil and the high pressure fuel acting on the top surface of the valve member 22. In order to control the quantity (volume) pumped at high pressure, the energization of the coil is timed to close the valve member 22 corresponding to a certain position on the upward stroke of the cam/piston. Prior to the valve closure, when the piston is moving upward, low pressure is being pushed backwards from the pumping chamber past the inlet valve 22 all the way to the pressure dampers 2 and inlet fitting 1. The dampers absorb much of the pressure spike associated with this backflow. This can be considered a “pumping bypass” phase of the overall piston reciprocation cycle. The overall cycle thus comprises a charging phase, a pumping bypass phase, and a high pressure pumping phase.

In a known manner, the electromagnetic coil assembly 15 is analogous to a solenoid, with a multi-winding coil situated around an axially extending, ferromagnetic cylinder or rod 21 (hereinafter referred to as magnetic pole). One end of the pole projects fronm the coil. When an electrical current is passed through the coil assy 15, a magnetic field is generated, which flows about the magnetic circuit along magnetic flux lines across radial air gap 23, generating an axial force onto the face of the valve 22 via the varying magnetic air gap 16. When the magnetic force exceeds the force of the inlet valve return spring 24, the valve 22 will close against valve sealing surface 20. The magnetic pole 21 integrally defines sealing surface 20 and is also a part of the magnetic flux path 32. Preferably, an inlet valve stop 14 aids in positioning of the valve 22 for accurate stroke control.

First magnetic break 17 and second magnetic break 18 surround the sealing face 20 to direct the correct magnetic flow path and avoid a magnetic short circuit. Both breaks 17 and 18 should be fabricated from a non-magnetic material and for best performance valve stop 14 should also be fabricated from a non-magnetic material. Breaks 17 and 18 surround the projecting portion of the magnetic pole to prevent magnetic flux from travelling radially to the housing from the pole and thereby short-circuiting the valve member 22. The breaks therby assure that the flux circuit passes through the coils, the magnet pole, through the sealing surface 20 and air gap 16, through the inlet valve member 22, across radial air gap 23, through conductive ring 31 and pump housing 3, back to the coil 15. In an alternative embodiment, the sealing surface 20′ is not unitary with the pole 21; it could be integrated with the second magnetic break 18.

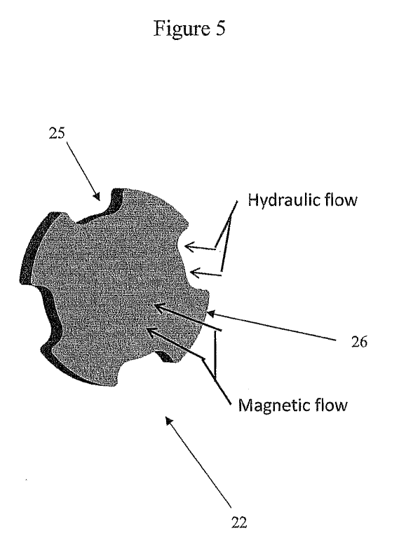

FIG. 5 shows additional features which contribute to efficient performance of the disclosed inlet valve assembly. The periphery of the valve member 22 includes a plurality of magnetic flow rim sections or lobes 26 which control the radial air gap 23, and a plurality of hydraulic flow notches 25 which facilitate adequate fuel flow along fluid flow path 19 when the valve opens. The lobes have a rim diameter (max OD) and the notches have a base diameter (min OD). The base diameter is larger than the ID of the valve sealing surface 20, so when the valve 22 is closed during the pumping stroke no flow can pass from pumping chamber across the valve 22 back to the inlet annulus 4′. The min OD should also be at approximately the same diameter as the diameter of the sealing surface 20 to allow sufficient magnetic force across magnetic air gap 16. When valve 22 opens during the charging stroke, fuel flows from the inlet annulus 4′ through the notches and through the radial air gap 23. The notches are provided because the air gap 23 must be minimized to maintain sufficient magnetic force, but as a result the annular flow area would otherwise be too small to permit the necessary inlet flow rate to the pumping chamber.

As a stand-alone unit, the disclosed fuel inlet valve assembly 5 shown in FIGS. 3 and 4 can be considered as providing a controlled intermediate flow path within the overall pump inlet flow path 19. A magnetic valve member 22 is situated within the intermediate flow path. The intermediate flow path comprises a valve assembly inflow path 19′ fluidly connected to inlet path 19a and starting at inlet annulus 4, and valve assembly outflow path 19″ starting downstream of the valve member 22 and ending at flow path 19b into passage 6. The magnetic pole 21 is a rod or cylinder or the like coaxially situated within the magnetic coil 15 and includes one end 27 projecting from the coil 15. A portion 19′ of the inflow path passes through transverse holes 28 in the projection of the pole and into a central bore 29, which opens through a sealing face 20 integrally formed at the end of the projection. The inlet valve member 22 is a flat plate that constitutes an armature in relation to the coil 15 and has a sealing face 30 that confronts the sealing surface 20 through a magnetic air gap 16. When lifted off the sealing surface 20, the valve member 22 opens fluid communication from the inflow path 19′ (upstream of the sealing surface 20) to the outflow path 19″ (downstream of the sealing surface). The valve member 22 includes a periphery with a rim 26 that provides magnetic flux paths transversely through the valve member and notches 25 that form another portion of the valve assembly outflow flow path when the valve member is open.

The present improvement is preferably implemented in the previously described hardware, entirely via digitally controlled timing of the magnetic field at the valve. The valve is either directly coupled to the magnetic field or physically attached to an armature that is in turn directly coupled to the magnetic field. In FIG. 2, the engine control unit (ECU) is shown receiving an input signal from a sensor of the cam angular position and the ECU outputs an actuation signal to the inlet valve actuator for implementing the timing for the partial charge operating strategy. The ECU also monitors engine RPM and rail pressure.

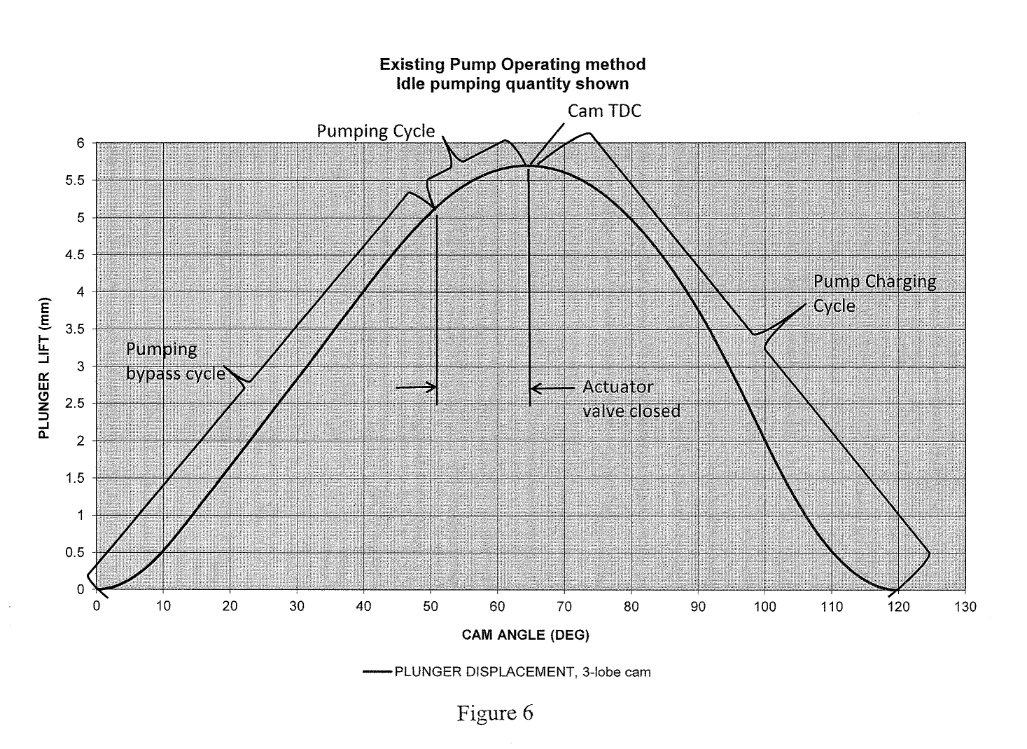

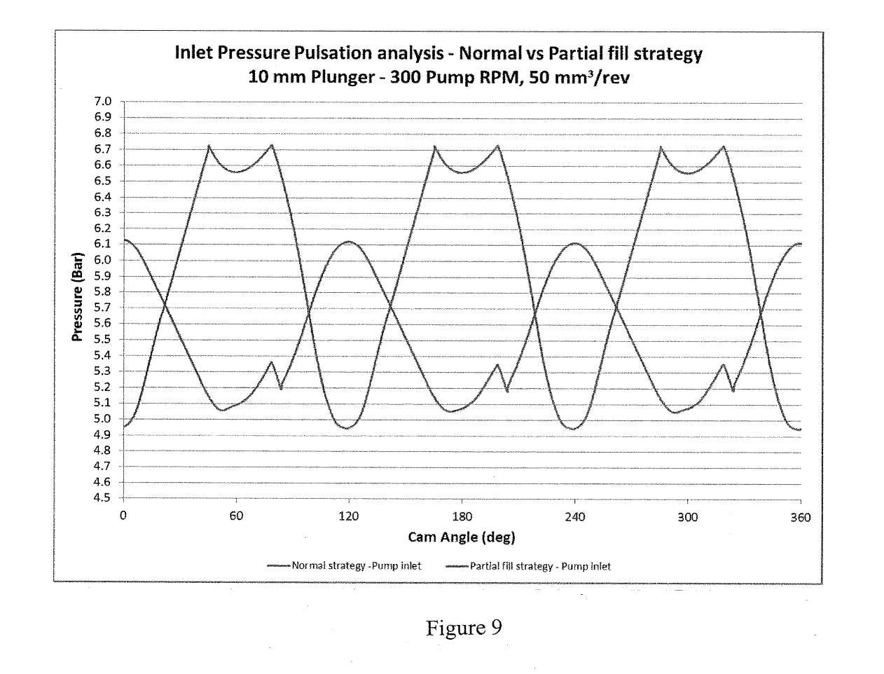

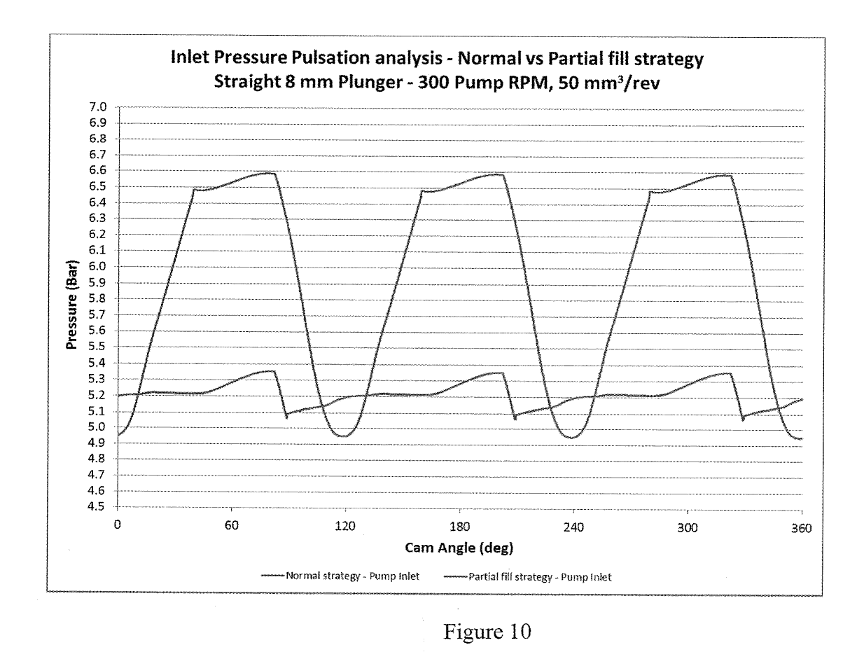

FIGS. 6-8 depict the conventional baseline “full charge” strategy and two methods for the inventive partial charge strategy. The resulting benefits are shown in FIGS. 9 and 10. In normal operation mode, the pumping bypass cycle occurs when the plunger pushes the fuel backwards out of the pumping chamber (with actuator valve open) but does not pressurize it. The vapor generation cycle and vapor collapse cycle are terms to describe the conditions in the pumping chamber during a partial charge operating scenario.

The conventional operating scheme can be characterized as “fully charge, spill, then pump over the cam nose.” The inventive scheme can be characterized as “partial charge, then pump over the cam nose”; this is a form of “inlet metered”.

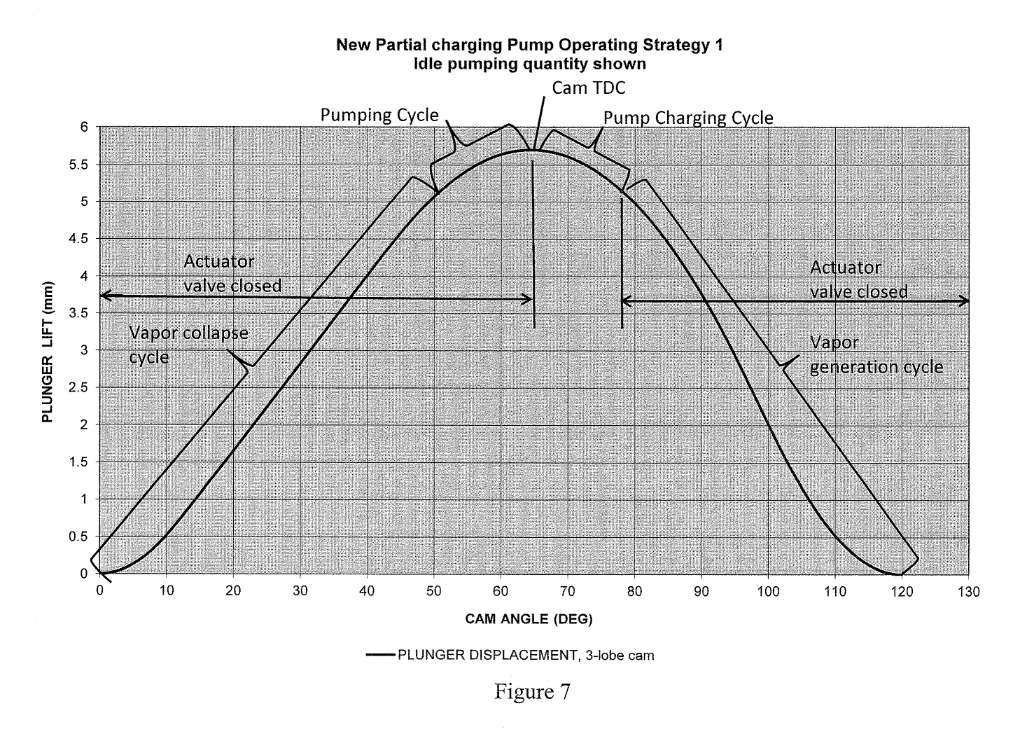

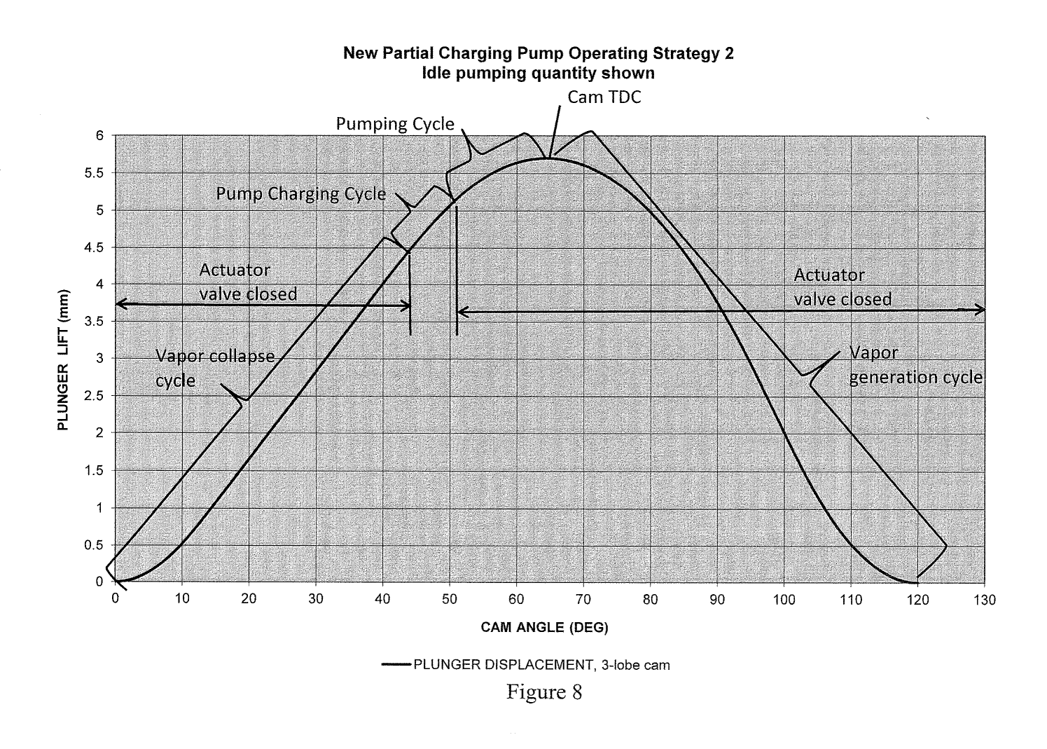

FIGS. 7 and 8 support the general concept of a single piston fuel pump comprising a pumping plunger reciprocally driven in a pumping chamber by a rotating cam, with the pumping chamber subject to intermittent charging of feed fuel by an inlet valve that is either directly coupled to a magnetic field or physically attached to an armature that is directly coupled to a magnetic field; and a control system responsive to the angular position of the cam, for controlling the inlet valve by altering the magnetic field to partially charge the pumping chamber before the plunger pressurizes the partially charged fuel while driven along the nose of the cam.

According to the exemplary scheme of FIG. 7, the pumping chamber is partially charged while the plunger is driven along the downslope of the nose and remains partially charged until the plunger pressurizes the partially charged fuel along the upslope of the nose of the cam. According to the exemplary scheme of FIG. 8, the pumping chamber is partially charged while the plunger is driven on the upslope approaching the nose of the cam and plunger pressurizes the partially charged fuel on the upslope of the nose of the cam.

For the depicted three-lobe cam, each lobe has a 120 deg. cycle. For an idle condition, the pump partial charging is completed within less than 15 deg. of cam rotation (i.e., while the valve is open). However, the angular duration of the open valve for charging depends on the quantity demand, and can include full charging. Similarly, the pumping cycle at idle is shown as implemented along an angular span of about 15 deg. This can also increase as demand increases. For idle and low demand conditions, the partial charging and associated pumping both occur along only a small angular span of the nose of the cam. For present purposes, the nose can be considered as about one-third of the total cam profile, centered at top-dead center. In general, the pumping will occur along the upslope of the nose up to the cam top dead center.

It should thus be appreciated that the present invention does not require partial charging under all operating conditions. Rather, the partial charging is a feature that is present during at least some of the operating conditions, especially at idle.

1. A single piston fuel pump comprising: a pumping plunger reciprocally driven in a pumping chamber by a rotating cam, with the pumping chamber subject to intermittent charging of feed fuel by an inlet valve that is either directly coupled to a magnetic field or physically attached to an armature that is directly coupled to a magnetic field; and a control system responsive to the angular position of the cam, for controlling the inlet valve by altering the magnetic field to partially charge the pumping chamber before the plunger pressurizes the partially charged fuel while the pumping plunger driven along the nose of the cam.

2. The pump of claim 1, wherein the pumping chamber is partially charged while the pumping plunger is driven along the downslope of the nose and remains partially charged until the plunger pressurizes the partially charged fuel along the upslope of the nose of the cam.

3. The pump of claim 1, wherein the pumping chamber is partially charged while the pumping plunger is driven along the upslope of the nose of the cam and the pumping plunger pressurizes the partially charged fuel while further along the upslope of the nose of the cam.

4. A fuel pump comprising a pump housing, a fuel inlet connection on the housing for delivering feed fuel into an inlet flow path in the housing; a pumping chamber and associated pumping mechanism in the housing for receiving feed fuel from the inlet flow path through an inlet valve assembly, increasing the fuel pressure, and delivering fuel at said increased pressure to a discharge flow path; an outlet connection on the housing, in fluid communication with the discharge flow path through an outlet valve; wherein the inlet valve assembly includes a valve member directly magnetically coupled to an electromagnetic coil, whereby the coil is selectively energized to generate a magnetic flux path directly through the inlet valve member, thereby applying a magnetic force to said valve member to selectively open and close said valve member against a sealing surface in said inlet flow path; and a control system for altering the magnetic field to partially charge the pumping chamber before the pumping plunger pressurizes the partially charged fuel.

5. The fuel pump of claim 4, wherein the valve member has a sealing face that mates with said sealing surface, and the magnetic force is applied at said sealing face.

6. The fuel pump of claim 4, wherein the inlet valve assembly includes a central magnetic pole coaxially situated within the coil; the sealing surface is situated at one end of the pole; and said magnetic force is applied to the valve member through said sealing surface.

7. The fuel pump of claim 4, wherein the inlet valve assembly includes a central magnetic pole coaxially situated within and including one end projecting from the coil; a portion of the inlet flow path passes through the projection of the pole into a central bore that opens at said one end of the projection; said sealing surface is integrally formed in the pole around said opening of the central bore; and the inlet valve member is a flat plate having a sealing face confronting the sealing surface and a periphery with a rim that provide magnetic flux paths transversely through the valve member and notches that form another portion of the inlet flow path when the valve member is open.

8. A method of controlling feed fuel in a charging phase of a high pressure fuel supply pump through an inlet flow valve assembly, which pump includes
a cam-driven pumping plunger reciprocable in a pumping chamber;
a valve assembly inflow path and valve assembly outflow path;
a magnetic valve member situated in an intermediate position fluidly linking the inflow path and the outflow path;
a magnetic pole confronting the valve member;
a selectively energizable coil for generating a magnetic flux directly magnetically coupling the pole and the valve member;
whereby the valve member opens and closes fluid communication between the inflow path and the outflow path in response to the energized state of the coil; and
wherein said method comprises controlling the magnetic flux to partially charge the pumping chamber before the pumping plunger pressurizes the partially charged fuel while the pumping plunger is driven along the nose of the cam.

9. The method of claim 8, wherein the pumping chamber is partially charged while the plunger is driven along the downslope of the nose and remains partially charged until the pumping plunger pressurizes the partially charged fuel along the upslope of the nose of the cam.

10. The method of claim 8, wherein the pumping chamber is partially charged while the plunger is driven along the upslope approaching the nose of the cam and the pumping plunger pressurizes the partially charged fuel while further along the upslope of the nose of the cam.

11. (canceled)
